(19) United States
(12) Patent Application Publication
(10) Pub. No.: US 2015/0125752 A1
(43) Pub. Date: May 7, 2015

(54) NEGATIVE ELECTRODE ACTIVE MATERIAL FOR LITHIUM ION SECONDARY BATTERY AND LITHIUM ION SECONDARY BATTERY

(71) Applicant: HITACHI, LTD., Tokyo (JP)

(72) Inventors: Etsuko Nishimura, Tokyo (JP); Akihide Tanaka, Tokyo (JP); Daiko Takamatsu, Tokyo (JP); Tatsumi Hirano, Tokyo (JP); Keiji Okabe, Tokyo (JP)

(73) Assignee: HITACHI, LTD., Tokyo (JP)

(21) Appl. No.: 14/394,920

(22) PCT Filed: Apr. 19, 2013
(86) PCT No.: PCT/JP2013/061561

§ 371 Date: Oct. 16, 2014

(30) Foreign Application Priority Data
Apr. 19, 2012 (JP) 2012-095505

(51) Int. Cl. H01M 4/36; H01M 4/587; H01M 4/133

(52) U.S. Cl. CPC H01M 4/366; H01M 4/133; H01M 4/587; H01M 2004/027
USPC 429/231.4

(57) ABSTRACT

Conventionally, there is a problem that a volume of a negative electrode active material changes during a charge-discharge cycle, a conductive network in a negative electrode gradually degrades, and thus a capacity of the negative electrode decreases. To solve the problem, the present invention has an object to prevent a reduction in capacity of the negative electrode, and increase life of a lithium ion secondary battery. A negative electrode active material for lithium ion secondary battery includes: a graphite core material; and a covering layer that covers a surface of the core material, wherein the covering layer has a thickness of 1 nm to 200 nm, and has a bulk modulus lower than a bulk modulus of the core material.

### TECHNICAL FIELD

The present invention relates to a negative electrode active material for lithium ion secondary battery, and a lithium ion secondary battery using the same.

### BACKGROUND ART

Lithium ion secondary batteries have attracted attention as batteries having high energy density which are used for electric automobiles or electric power storage. In particular, examples of electric automobiles include a zero-emission electric automobile without an engine, a hybrid electric automobile including both an engine and a secondary battery, and further a plug-in hybrid electric automobile charged by a system power source. Also, the lithium ion secondary battery is expected to be used as a stationary electric power storage system that stores electric power and supplies electric power in an emergency when an electric power system is interrupted.

Such use requires high durability in a charge-discharge cycle. In the charge-discharge cycle, a volume of crystal in a negative electrode active material changes with occlusion and emission of lithium ions. Particles of the negative electrode active material first adhering to each other start gradual separation with increasing number of charge-discharge cycles, thereby reducing electron conductivity between the particles. This reduces a capacity of a negative electrode. Thus, there is a need for a negative electrode active material that does not reduce electron conductivity in the negative electrode.

In order to prevent a reduction in capacity or degradation of a cycle during high temperature storage, electrode materials or electrolytes with high durability have been developed, and among them, many inventions relating to a negative electrode structure have been proposed. Typical examples thereof include Patent Literatures 1 to 4.

Patent Literature 1 discloses a technique of providing to a negative electrode a liquid-absorbing property such that a contact angle between a liquid drop and a negative electrode mixture layer is 10 degrees within 100 seconds when propylene carbonate is dropped on the negative electrode mixture layer, thereby increasing a charge-discharge cycle property.

Patent Literature 2 discloses an active material with a conductive material adhering to a surface of active material powder, and with an electrical connection between the active material powder and the conductive material being stably maintained.

In Patent Literature 3, resin having an elastic modulus of 3.0 GPa or more, preferably, polyimide resin is used as a binder in a negative electrode for a lithium secondary battery containing tin as an active material, thereby increasing a charge-discharge cycle property of the negative electrode.

Patent Literature 4 discloses an invention in which two types of binders having different elastic moduli are used to provide a void ratio of a negative electrode of 18% to 70%, thereby increasing a cycle property.

### CITATION LIST

### Patent Literature

Patent Literature 1: Japanese Patent Publication (Kokai) No. 2004-22507
Patent Literature 2: Japanese Patent Publication (Kokai) No. 2008-277128
Patent Literature 3: Japanese Patent Publication (Kokai) No. 2007-149604
Patent Literature 4: Japanese Patent Publication (Kokai) No. 2009-224239

### SUMMARY OF INVENTION

### Technical Problem

As described above, the volume of the negative electrode active material changes in the charge-discharge cycle, which gradually degrades a conductive network in the negative electrode, and thus reduces the capacity of the negative electrode. The present invention has an object to prevent a reduction in capacity of a negative electrode, and increase life of a lithium ion secondary battery.

### Solution to Problem

To achieve the object, the present inventors have diligently studied and found that it is important to have a mechanical property such that a particle of a negative electrode active material has a two-layer structure including a core material and a covering layer, and the covering layer follows expansion and contraction of the core material in a charge-discharge cycle. Using such a negative electrode active material can prevent a reduction in capacity of a negative electrode due to the charge-discharge cycle, and increase life of a battery.

Specifically, the present invention provides a negative electrode active material for lithium ion secondary battery including: a graphite core material; and a covering layer that covers a surface of the core material, wherein the covering layer has a thickness of 1 nm to 200 nm, and has a bulk modulus lower than a bulk modulus of the core material.

### Advantageous Effects of Invention

According to the present invention, a negative electrode in which a reduction in capacity due to a charge-discharge cycle is prevented can be obtained. Using the negative electrode can increase life of a lithium ion secondary battery. Problems, configurations, and advantages other than those described above will be clarified by descriptions on embodiments mentioned below.

### BRIEF DESCRIPTION OF DRAWINGS

FIG. 1 is a sectional view of an embodiment of a lithium ion secondary battery according to the present invention.

FIG. 2 shows an embodiment of a battery module.

### DESCRIPTION OF EMBODIMENTS

Now, the present invention will be described in detail.

A negative electrode active material for lithium ion secondary battery according to the present invention includes a core material of graphite particles, and a covering layer on a surface of the core material. The covering layer has a predetermined thickness, and has a bulk modulus lower than a bulk modulus of the core material. Because of such a magnitude relation between the bulk moduli, if a volume of the core material expands and contracts with occlusion and emission of lithium ions during a charge-discharge cycle, the covering layer follows the change in volume, thereby preventing the covering layer from being separated from the core material or damaged. This prevents degradation of the negative electrode active material, and increases the life of the battery. Next, a configuration of the lithium ion secondary battery using the negative electrode active material will be described.

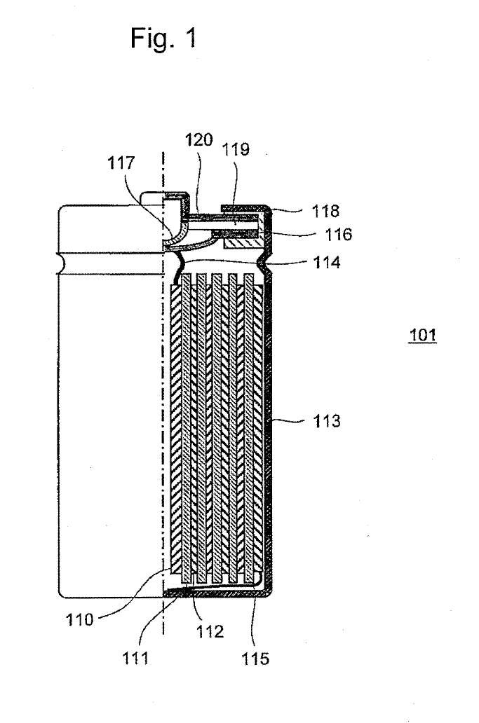

FIG. 1 schematically shows an internal structure of an embodiment of the lithium ion secondary battery according to the present invention. The lithium ion secondary battery is an electrochemical device that allows storage or use of electric energy by occlusion and emission of lithium ions into and from an electrode in a non-aqueous electrolyte. A lithium ion secondary battery 101 in FIG. 1 includes a positive electrode 110, a separator 111, a negative electrode 112, a battery can 113, a positive electrode power collection tab 114, a negative electrode power collection tab 115, an inner lid 116, an internal pressure open valve 117, a gasket 118, a positive temperature coefficient (PTC) resistance element 119, and a battery lid with positive electrode terminal 120. The battery lid with positive electrode terminal 120 is integrally configured with the inner lid 116, the internal pressure open valve 117, the gasket 118, and the PTC resistance element 119. The battery lid with positive electrode terminal 120 may be mounted to the battery can 113 by swaging or other methods such as welding or bonding.

Although the battery can 113 in FIG. 1 has a bottom, a cylindrical container without a bottom may be used instead, a battery lid may be mounted to a bottom surface of the cylindrical container, and further, a negative electrode may be connected to the battery lid. Depending on methods of mounting a terminal, a battery container of any shape may be used, and any containers do not affect the advantage of the present invention.

The positive electrode 110 includes a positive electrode active material, a conductive agent, a binder, and a power collector. Typical examples of the positive electrode active material include LiCoO₂, LiNiO₂, LiMn₂O₄, or the like. Other examples include LiMnO₃, LiMn₂O₃, LiMnO₂, Li₄Mn₅O₁₂, LiMn₂₋ₓMₓO₂ (M is a metal element such as Co, Ni, Fe, Cr, Zn, or Ta, and x is 0.01 to 0.2), Li₂Mn₃MO₈ (M is a metal element such as Fe, Co, Ni, Cu, or Zn), Li₁₋ₓAₓMn₂O₄ (A is a metal element such as Mg, Ba, Al, Fe, Co, Ni, Cr, Zn, or Ca, and x is 0.01 to 0.1), LiNi₁₋ₓMₓO₂ (M is a metal element such as Co, Mn, Fe, or Ga, and x is 0.01 to 0.2), LiFeO₂, Fe₂(SO₄)₃, LiCo₁₋ₓMₓO₂ (M is a metal element such as Ni, Fe, Mn, and x is 0.01 to 0.2), LiNi₁₋ₓMₓO₂ (M is a metal element such as Mn, Fe, Co, Al, Ga, or Ca, and x is 0.01 to 0.2), Fe(MoO₄)₃, FeF₃, LiFePO₄, LiMnPO₄, or the like, but the positive electrode active material is not limited to these examples.

A particle size of the positive electrode active material is defined to be smaller than a thickness of a mixture layer. If positive electrode active material powder contains coarse particles having a size larger than the thickness of the mixture layer, the coarse particles are previously removed by sieve classification, wind flow classification, or the like to prepare particles having a size smaller than the thickness of the mixture layer. The particle size is measured using a laser diffraction and scattering particle size distribution measurement device (device using microtracking). In the present invention, the particle size refers to a numerical value calculated from particle size distribution of an aggregate of spherical particles that present the same scattering pattern as a laser light scattering pattern.

Also, the positive electrode active material is generally oxide based and has high electric resistance, and thus a conductive agent of carbon powder is used to supplement electric conductivity. As the conductive agent, carbon materials such as acetylene black, carbon black, graphite, or amorphous carbon may be used. To faun an electronic network in the positive electrode, an average particle size of the conductive agent is smaller than an average particle size of the positive electrode active material, and desirably 1/10 or less of the average particle size of the positive electrode active material.

Since the positive electrode active material and the conductive agent are both in powder form, a binder is mixed in the powders to bond the powders each other and to the power collector.

As the power collector, aluminum foil having a thickness of 10 μm to 100 μm, aluminum perforated foil having a thickness of 10 μm to 100 μm and a hole diameter of 0.11 mm to 10 mm, expanded metal, a foam metal plate, or the like is used. The power collector may be made of aluminum, and also stainless steel, titanium, or the like. In the present invention, the power collector may be made of any materials as long as they are not dissolved or oxidized during use of the battery, without being limited by materials, shapes, manufacturing methods, or the like.

To fabricate the positive electrode 110, a positive electrode slurry needs to be prepared. Composition of the slurry is changed depending on types of materials to be mixed in the slurry, specific surface areas, particle size distribution, or the like, and is not particularly limited. As an example, the slurry may include 89 parts by weight of positive electrode active material, 4 parts by weight of acetylene black, and 7 parts by weight of polyvinylidene fluoride (PVDF) as a binder. A solvent of the positive electrode slurry may dissolve the binder, and is selected depending on types of the binder. For example, 1-methyl-2-pyrolidone is often used as a solvent when the binder is PVDF. For dispersion of the positive electrode slurry, a known kneader or disperser may be used.

The positive electrode may be fabricated by applying the positive electrode slurry including a mixture of the positive electrode active material, the conductive agent, the binder, and the solvent to the power collector by a doctor blade method, dipping, spraying, or the like, then drying the solvent, and pressure forming the positive electrode by roll pressing or the like. Repeating the process from application to drying several times allows a plurality of mixture layers to be stacked on the power collector.

The negative electrode 112 includes a negative electrode active material, a binder, and a power collector. The negative electrode active material has a structure in which a covering layer is formed on a surface of a graphite core material (particle), a so-called core-shell structure. The core material is a carbon material having a graphene stacking structure (graphite structure). The negative electrode active material desirably has a spherical, massive, or flat spherical shape, but may have a shape with a high aspect ratio such as a scale or fibrous shape. A particle size of the negative electrode active material at a frequency of 50% (median diameter D₅₀) is preferably 3 μm to 30 μm. The particle size is measured using a laser diffraction and scattering particle size distribution measurement device (device using microtracking).

The graphite core material may be obtained by mixing, for example, coke powder, tar pitch, silicon carbide, coal tar, or the like, pulverizing and pressure forming an obtained mixture into a pellet, then burning the mixture at around 3000° C. in nitrogen atmosphere, and pulverizing the obtained burned product using a hammer mill.

As the coke powder, powder having a particle size of 1 μm to several tens μm may be selected. Composition of components of coke powder, tar pitch, or the like may be changed. Other conditions such as heat treatment temperature are not limited to the above.

Also, natural graphite may be used instead of artificial graphite described above. For example, the natural graphite is pulverized to fabricate powder, which is classified to have an average particle size within a range of 5 μm to 20 μm by a wind flow classification device. A binder pitch is added to graphite particles obtained by granulating the powder into a substantially spherical shape using the binder, and the particles are heated and mixed and then burned at 800° C. to 1400° C. The average particle size of the core material is not particularly limited, but needs to be smaller than the thickness of the negative electrode.

Neither the artificial graphite nor the natural graphite affects the advantage of the present invention. In particular, a (002) interplanar spacing d₀₀₂ by wide-angle X-ray diffraction of the graphite core material is preferably 0.3345 nm to 0.3370 nm. Within this range, a large occlusion amount of lithium ions at a low negative electrode potential and an increased energy (Wh) of the battery are obtained. Also, even for a two-layer structure including the core material and the covering layer, a large capacity greater than 350 mAh/g can be preferably obtained.

Also, a c-axis length (hereinafter referred to as Lc) of graphite crystal of the core material is preferably 20 nm to 90 nm, but not limited to this.

A bulk modulus of the core material itself is measured before the covering layer is formed on a core material surface. For measuring the bulk modulus, for example, a method using a submicroscopic probe for a nanoindentati on approach is used (see Japan Society for the Promotion of Science, Carbon material, ed. by the 117th committee, New Development of Carbon material, pp. 197 to 210; Applied Physics, Vol. 79, No. 4, pp. 341 to 345, 2010; and Kobe Steel Engineering Reports, Vol. 52, No. 2, pp. 74 to 77, 2002). The submicroscopic probe may have any shape, but probes used for measuring the core material and the covering layer, respectively, have the same material and shape. Typically, the probe has a conical or regular pyramidal shape.

As another method for measuring the bulk modulus, an atomic force microscopy may be used to pressure bond a probe thereof to a core material surface, and measure a force of pressure bonding to measure the bulk modulus (see Applied Physics, Vol. 79, No. 4, pp. 341 to 345, 2010). Any other methods may be used as long as they can compress a surface of one particle and measure stress thereof.

The bulk modulus of the covering layer is measured with the covering layer being formed on the core material. Although the influence of the bulk modulus of the core material cannot be completely eliminated, the bulk modulus of the covering layer in the present invention is defined as an actual measurement value with the core material underlying the covering layer.

The bulk modulus of the core material may take various values depending on types of raw materials, heat treatment conditions, or the like. However, in order to obtain a capacity close to a theoretical capacity of 372 mAh/g, the bulk modulus of the core material is desirably 5 GPa to 20 GPa. If the negative electrode active material particle is compression deformed in a press process during fabrication of an electrode, the bulk modulus of the core material is preferably 8 GPa or more. Since too high a bulk modulus causes insufficient flexibility, a core material having a bulk modulus of 14 GPa or less is further preferable. Selecting a core material having a bulk modulus of 5 GPa to 20 GPa, desirably 8 GPa to 14 GPa while satisfying requirements of a specific surface area, a d₀₀₂ value, an Lc value, a Raman peak intensity ratio, a D₅₀ value, or the like defined in the present invention provides a capacity extremely close to the theoretical capacity, and a superior charge-discharge cycle property.

Next, a method of forming the covering layer on the core material surface will be described. The covering layer is made of a carbonaceous material, but may contain a small amount of nitrogen, phosphorus, oxygen, alkali metal, alkali-earth metal, transition metal, or the like. If the covering layer allows passage of lithium ions, and has a predetermined bulk modulus, the advantage of the present invention can be obtained.

The covering layer preferably has a thickness of 1 nm to 200 nm, particularly, 5 nm to 150 nm. Too thin a covering layer may cause permeation of the electrolyte and reductive decomposition of the electrolyte on the core material surface. On the other hand, too thick a covering layer may inhibit diffusion of lithium ions, and reduce the capacity in a high current.

A covering layer mainly containing carbon is the most suitable. The covering layer mainly containing carbon desirably has a dense structure with a few pores. This is because many pores in the covering layer cause the solvent in the electrolyte to permeate the covering layer, and causes reductive decomposition on the core material surface.

The covering layer mainly containing carbon may be formed by the following procedure. First, 100 parts by weight of a graphite core material is immersed in 160 parts by weight of methanol solution of novolac-type phenolic resin (manufactured by Hitach Chemical Company, Ltd.), and dispersed to fabricate a graphite particle and phenolic resin mixture solution. The solution is sequentially filtered and dried, and subjected to heat treatment at 200° C. to 1000° C., thereby obtaining a graphite particle (negative electrode active material) with a core material surface covered with carbon. Of course, the composition of the mixed solution and the heat treatment temperature are not limited to the above conditions.

The covering layer mainly containing carbon may be formed by a method different from the above. For example, the core material may be covered with polyvinyl alcohol and thermally decomposed. In this case, the heat treatment temperature may be 200° C. to 400° C. In particular, the temperature of 300° C. to 400° C. is desirable because the covering layer is more firmly bonded to the core material.

Further, as an alternative, the core material may be treated with an oxygenated organic compound such as polyvinyl chloride, polyvinylpyrrolidone, or the like. Such a compound is mixed with graphite powder, and then heated to a thermal decomposition temperature to form a covering layer mainly containing carbon.

The thickness of the covering layer may be controlled by increasing or reducing an addition amount of carbon material such as phenolic resin or polyvinyl alcohol with respect to a weight of the core material, or adjusting the heat treatment condition.

The thickness of the covering layer may be measured using a transmission electron microscope (TEM) in such a manner that a low crystallinity covering layer is formed on the surface of the graphite core material as described above, and then a section of powder having a core-shell structure is cut out by a focused ion beam processing device.

The negative electrode active material thus fabricated has a two-layer structure including the core material and the covering layer that covers the surface of the core material. The covering layer having a thickness of 1 nm to 200 nm, and having a bulk modulus lower than the bulk modulus of the core material can prevent a reduction in capacity of the negative electrode, which is the object of the present invention. The method for manufacturing the negative electrode active material is not limited to the above described method, but any methods may be selected as long as the bulk modulus of the covering layer is lower than the bulk modulus of the core material.

In order to more effectively prevent the reduction in capacity of the negative electrode, the bulk modulus of the covering layer is preferably 50% to 95% of the bulk modulus of the core material. The ratio between the bulk moduli depends on density of the covering layer, a crystallite size, presence or absence of pores or defects, a thickness, or the like, and can be controlled by a manufacturing method and manufacturing conditions such as a raw material of the covering layer or a thermal decomposition temperature.

Also, the (002) interplanar spacing of the core material determined by X-ray diffraction is preferably 0.3345 nm to 0.3370 nm. Such a negative electrode active material includes the core material with graphite crystal inside, thereby providing a negative electrode having a high capacity.

Also, a ratio of a specific surface area of the negative electrode active material actually measured by gas adsorption to a specific surface area of the negative electrode active material calculated based on particle size distribution of an equal volume sphere of the negative electrode active material (hereinafter referred to as a specific surface area ratio) is preferably in a range of 1 to 30. In the present invention, a nitrogen gas is used to actually measure the specific surface area. If the negative electrode active material does not include the covering layer, that is, the negative electrode active material includes only the core material, the specific surface area ratio is larger than 30. Since the core material surface has minute irregularities, or has pores therein, the specific surface area measured by gas adsorption reflects such minute irregularities. On the other hand, the specific surface area of the equal volume sphere of the particle calculated by measurement of the particle size distribution is calculated with an ideal sphere having a smooth surface without considering minute irregularities of each particle.

The specific surface area is calculated from the particle size distribution by the following method. The particle size is delimited by minute sections, and a product of A and B is obtained, where A is a frequency of the number of particles in a minute section (expressed in percentage), and B is a surface area calculated with a median value in the section as a diameter of the particle. Similarly, a product of A and C is obtained, where C is a volume of a particle calculated with the median value in the minute section as a diameter of the particle. A cumulative value of A×B for all sections is divided by a cumulative value of A×C for all sections to obtain a specific surface area (in cm²/cm³) per unit volume. Real density of the particles is calculated by a known analyzing approach such as liquid phase substitution (pycnometer method), and then a specific surface area per unit weight (in cm²/g) can be calculated by multiplying the specific surface area per unit volume by the real density of the particles. Since this value is expressed in the same unit as the specific surface area calculated by the gas adsorption (BET method), the BET specific surface area is divided by the specific surface area per unit weight calculated from the particle size distribution to obtain the specific surface area ratio.

The minute section refers to a section provided by dividing an entire section of a range of diameters of particles into more than 100 sections, and the number of divided sections is as large as possible. The divided sections may be equal, but may be increased in geometric progression or exponentially with increasing diameter. In the example described later, the section of the measured particle size is exponentially increased.

The core material before being covered has irregularities in the surface, but when the covering layer starts to be formed on the core material, minute irregularities are gradually covered by the covering layer with few irregularities. Thus, the specific surface area ratio of the negative electrode active material including the covering layer is 30 or less. The lowest specific surface area ratio corresponds to formation of a dense covering layer without irregularities, and a lower limit value is 1.

The specific surface area ratio in a range of 3 to 30 is further preferable for obtaining the advantage of the present invention. The specific surface area ratio is 30 or less, and thus the surface has a moderate number of pores, lithium ions quickly reach the core material and arc occluded into the core material, while the lithium ions are easily emitted from the core material into the electrolyte. A lower specific surface area ratio can increase the life of the negative electrode. This is because of a reduction in contact area with the electrolyte, and also a reduction in irreversible capacity due to reductive decomposition of the electrolyte. Also, since too low a specific surface area ratio tends to reduce the number of pores and reduce a rate property of the negative electrode, a desirable specific surface area ratio is 3 or more. A specific surface area ratio of 5 or more is further preferable because it allows charging and discharging in a high current of 3 C or more (current corresponding to a ⅓ hour rate).

On the other hand, if the specific surface area ratio exceeds 30, the number of pores excessively increases, and the solvent of the electrolyte starts decomposing on the core material surface to increase the irreversible capacity and reduce the initial capacity. Further, the charge-discharge cycle damages the covering layer, and reduces the life.

Further, the negative electrode active material according to the present invention preferably has a ratio I₁₃₆₀/I₁₅₈₀ of peak intensity of a 1360 cm⁻¹ region (D band) to peak intensity of a 1580 cm⁻¹ region (G band) is 0.1 to 0.6. The G band is more intense with increasing crystallinity of the covering layer (closer to crystal of graphite), and the D band is more intense with increasing amorphous nature. Thus, the peak intensity ratio is an indication of a degree of the amorphous nature on the surface of the negative electrode active material particle. The covering layer in the present invention is made of a material having a moderate amorphous nature with the peak intensity ratio of 0.1 to 0.6. For single graphite, the ratio tends to be lower than 0.1, and for an amorphous structure or a turbostratic structure (glassy structure), the ratio is 0.9 to 1.1.

Other materials that can electrochemically occlude and emit lithium ions may be mixed in the negative electrode 112 in addition to the negative electrode active material having the core-shell structure. Examples of such materials include carbon materials having a larger (002) interplanar spacing of graphite of more than 0.3370 nm, and carbon materials made of expanded graphite, a pitch-based carbonaceous material, needle coke, petroleum coke, or the like may be used. Further, an amorphous carbon material synthesized by thermal decomposition of carbon black or a five- or six-membered cyclic hydrocarbon or oxygenated organic compound may be added. An addition amount of the other materials is preferably smaller than an equal weight ratio with respect to the weight of the negative electrode active material having the core-shell structure. This is because a larger amount than the equal weight ratio reduces a ratio of graphite having a higher capacity than the amorphous carbon to noticeably reduce capacity density of the negative electrode.

The binder used in the negative electrode may be resin, pitch, or the like having adhesive power, and is not particularly limited. Examples of the binder include thermosetting resins such as phenolic resin, cellulosic resin, or epoxy resin, various resins such as naphthalene, anthracene, creosote oil, polyvinyl alcohol, styrene-butadiene rubber, coal-tar pitch, polyethylene, or the like, or mixtures thereof.

Examples of the power collector used in the negative electrode include a copper foil having a thickness of 10 μm to 100 μm, a copper perforated foil having a thickness of 10 μm to 100 μm and a hole diameter of 0.1 mm to 10 mm, expanded metal, a foam metal plate, or the like, and the power collector may be made of copper, and also stainless steel, titanium, nickel or the like. In the present invention, any power collectors may be used without being limited by materials, shapes, manufacturing methods, or the like.

The negative electrode may be fabricated by applying the negative electrode slurry including a mixture of the negative electrode active material, the binder, and an organic solvent to the power collector by a doctor blade method, dipping, spraying, or the like, then drying the organic solvent, and pressure forming the negative electrode by roll pressing. Repeating the process from application to drying several times allows multiple mixture layers to be formed on the power collector.

Next, a fabrication procedure of the lithium ion battery 101 shown in FIG. 1 will be described. The separator 111 is inserted between the positive electrode 110 and the negative electrode 112 fabricated by the above described method to prevent short-circuiting between the positive electrode 110 and the negative electrode 112. Examples of the separator 111 include a polyolefin-based polymer sheet made of polyethylene or polypropylene, or the like, a separator having a multilayer structure in which polyolefin-based polymer and a fluorine-based polymer sheet typified by polyethylene tetrafluoride adhere to each other, a separator to which aramid fiber is added, or the like may be used. A mixture of ceramic and a binder may be formed in a thin layer on a surface of the separator 111 so as to prevent contraction of the separator 111 at high battery temperatures. Such a separator 111 needs to permeate lithium ions during charging and discharging of the battery, and thus desirably generally has a pore of 0.01 μm to 10 μm in diameter, and porosity of 20% to 90%.

The separator 111 is also inserted between an electrode placed at an end of an electrode cluster and the battery can 113 so as to prevent short-circuiting between the positive electrode 110 and the negative electrode 112 via the battery can 113. In the surfaces and pores of the separator 111, the positive electrode 110, and the negative electrode 112, a non-aqueous electrolyte including an electrolyte and a non-aqueous solvent is retained.

The positive electrode 110 is connected to the inner lid 116 via the positive electrode power collection tab 114. The negative electrode 112 is connected to the battery can 113 via the negative electrode power collection tab 115. The positive electrode power collection tab 114 and the negative electrode power collection tab 115 may have any shape such as a wire shape or a plate shape. Any materials and shapes of the positive electrode power collection tab 114 and the negative electrode power collection tab 115 may be selected from metals such as nickel, aluminum, titanium, stainless steel, or copper depending on the structure of the battery can 113 as long as ohmic loss can be reduced when the current is passed, and the material does not react with the non-aqueous electrolyte.

The positive temperature coefficient (PTC) resistance element 119 is used to stop charging and discharging of the lithium ion secondary battery 101 and protect the battery when the temperature in the battery is high. The PTC may be made of conductive particles of carbon black, nickel, or the like dispersed in a polymer having a low melting point.

The electrode cluster may have a winding structure shown in FIG. 1, be wound into any shape such as a flat shape, or have various shapes such as a strip shape. The battery container may have a shape such as a cylindrical shape, a flat oval shape, or a square shape in accordance with the shape of the electrode cluster.

The battery can 113 is selected from a material such as aluminum, stainless steel, steel, or nickel-plated steel having corrosion resistance to the non-aqueous electrolyte. When the battery can 113 is electrically connected to the positive electrode power collection tab 114 or the negative electrode power collection tab 115, a material of a lead wire is selected so as to prevent corrosion of the battery container or degradation of the material due to alloying with lithium ions in a portion in contact with the non-aqueous electrolyte.

Then, the battery lid with positive electrode terminal 120 is brought into tight contact with the battery can 113 to seal the entire battery, and mount the battery lid with positive electrode terminal 120 to the battery can 113 by swaging or the like. To seal the battery, a known technique such as welding or bonding may be used. The terminal may be placed in any position and have any shape, and is not limited to the terminal shown in FIG. 1.

A typical example of the non-aqueous electrolyte usable in the present invention includes a solution in which lithium hexafluorophosphate (LiPF₆) or lithium borofluoride (LiBF₄) as an electrolyte is dissolved in a solvent containing a mixture of dimethyl carbonate, diethyl carbonate, ethylmethyl carbonate, or the like in ethylene carbonate. In the present invention, types of the solvent and the electrolyte, a mixing ratio of the solvent, or the like are not particularly limited, and other non-aqueous electrolytes may be used. The electrolyte may be used contained in an ion-conducting polymer such as polyvinylidene fluoride, or polyethylene oxide. In this case, there is no need for the separator.

Examples of the solvent usable in the non-aqueous electrolyte include non-aqueous solvents such as propylene carbonate, ethylene carbonate, butylene carbonate, vinylene carbonate, γ-butyrolactone, dimethyl carbonate, diethyl carbonate, methylethyl carbonate, 1,2-dimethoxyethane, 2-methyltetrahydrofuran, dimethylsulfoxide, 1,3-dioxolan, formamide, dimethylformamide, methyl propionate, ethyl propionate, phosphate triester, trimethoxymethane, dioxolan, diethyl ether, sulfolane, 3-methyl-2-oxazolidinone, tetrahydrofuran, 1,2-diethoxyethane, chlorethylene carbonate, or chlorpropylenecarbonate. Other solvents may be used if the solvents are not decomposed on the positive electrode or the negative electrode included in the lithium ion secondary battery of the present invention.

Examples of the electrolyte include multiple types of lithium salts such as imide salts of lithium typified by LiPF₆, LiBF₄, LiClO₄, LiCF₃SO₃, LiCF₃CO₂, LiAsF₆, LiSbF₆, or lithium trifluoromethanesulfonimide. A non-aqueous electrolyte containing such salts dissolved in the solvent described above may be used as the electrolyte for the lithium ion secondary battery. Other electrolytes may be used if the electrolytes arc not decomposed on the positive electrode or the negative electrode included in the lithium ion secondary battery of the present invention. Further, a flame retardant such as phosphate ester, phosphite ester, cyclic phosphate ester, cyclic phosphite ester, or cyclic phosphazene may be added to inhibit combustion of the electrolyte.

Examples of a method of injecting the non-aqueous electrolyte include a method of directly adding the non-aqueous electrolyte to the electrode cluster with the battery lid with positive electrode terminal 120 being removed from the battery can 113, or adding the non-aqueous electrolyte through an injection port provided in the battery lid with positive electrode terminal 120.

Instead of the non-aqueous electrolyte, a solid polymer electrolyte (polymer electrolyte) or a gel electrolyte may be used. When the solid polymer electrolyte is used, an ion conductive polymer such as a copolymer including polyethylene oxide, polyacrylonitrile, polyvinylidene fluoride, poly(methyl methacrylate), hexafluoropropylene may be used as the electrolyte. When such a solid polymer electrolyte is used, the separator 111 may be omitted. The gel electrolyte includes a mixture of polyvinylidene fluoride and a non-aqueous electrolyte. The ion conductive polymer may be replaced by a lithium ion conductive solid electrolyte, thereby obtaining the advantage of the present invention.

Further, an ionic liquid may be used. Examples of the ionic liquid include 1-ethyl-3-methylimidazolium tetrafluoroborate (EMI-BF₄), a mixed complex of lithium salt LiN(SO₂CF₃)₂(LiTFSI), triglyme, and tetraglyme, a cyclic quaternary ammonium cation such as N-methyl-N-propyl pyrrolidinium, and an imide anion such as bis(fluorosulfonyl)imide, and a combination of such ionic liquids that is not decomposed on the positive electrode and the negative electrode can be selected and used in the lithium ion secondary battery of the present invention.

### EXAMPLES

Now, the present invention will be described in more detail based on examples and comparative examples, but not limited to them.

A graphite core material was fabricated as descried below. First, 50 parts by weight of coke powder having an average particle size of 5 to 40 μm, 20 parts by weight of tar pitch, 7 parts by weight of silicon carbide having an average particle size of 48 μm, and 10 parts by weight of coal tar were mixed at 200° C. for one hour. An obtained mixture was pulverized, pressure formed into a pellet, and then burned at a predetermined temperature in nitrogen atmosphere. The obtained burned product was pulverized by a hammer mill, and a particle size was controlled by the wind flow classification device, thereby obtaining a core material containing minute graphite particles. Particle size distribution of the core material was measured using a particle size distribution analyzer, and a particle size at a frequency of 50% (median diameter D₅₀) was 3 μm to 40 μm.

Then, a covering layer was formed. Two covering methods were used here. As a first method, a novolac-type phenolic resin methanol solution was used as a raw material for forming the covering layer, and a carbonaceous covering layer was formed on a core material surface. The core material used was subjected to heat treatment at a high temperature of 2500° C. to have increased crystallinity of graphite. An addition amount of phenolic resin was increased so that an average thickness of the covering layer on the core material was 1 nm to 2 nm, 5 nm, 20 nm, 50 nm, 100 nm, 150 nm, and 200 nm, and graphite negative electrode active materials (NM1, NM2, NM3, NM4, NM6, and NM7) with seven types of covering layers were fabricated.

Nuclear materials of three types of graphite powders having median diameters D₅₀ of 3, 10, 30 μm were prepared, and covering layers were formed by the same method. For the core material, graphite was crushed and pulverized, and then a particle size was controlled using the wind flow classification device. Three types of negative electrode active materials: NM8, NM9, and NM10 were thus fabricated.

NM11 is a negative electrode active material fabricated by increasing a heat treatment temperature during manufacture of NM9 to 2800° C. to 2900° C., and increasing crystallinity of the covering layer of NM9. The heat treatment was performed in non-oxidizing atmosphere.

A core material with a slightly larger graphite interlayer spacing (d₀₀₂) was used, and carbonaceous covering was formed. Three types of negative electrode active materials: NM12, NM13, and NM14 were fabricated. The core material was synthesized by burning petroleum pitch at 2000° C. to 2500° C. in non-oxidizing atmosphere. The burned product was pulverized and classified to have the median diameter D₅₀ shown in Table 1 to obtain the core material. To a surface of the core material, naphthalene or polyvinyl alcohol was attached, and heat treatment was performed at 700° C. to 900° C. to obtain a negative electrode active material. For synthesizing NM12, NM13, and NM14 shown in Table 1, naphthalene was used, and a thickness of the covering layer was controlled depending on an addition amount of naphthalene. NM15 is a negative electrode active material in which a covering layer is formed by thermal decomposition of phenolic resin on a core material controlled to have a median diameter D₅₀ of 40 μm by wind flow classification.

As comparative examples, a negative electrode active material NM16 including only the core material used in NM1, a negative electrode active material NM17 including a core material made of amorphous carbon (hard carbon), a negative electrode active material NM18 in which a covering layer having a thickness of 1 nm is formed on the core material used in NM1 (the core material is partially exposed), and a negative electrode active material NM19 including a covering layer having an increased thickness of 250 nm to 300 nm were fabricated. NM20 is a negative electrode active material in which the core material (median diameter D₅₀ of 30 μm) used in NM10 is used, and a covering layer has a thickness of 250 nm to 300 nm. NM21 is a negative electrode active material in which a covering layer having a thickness of 250 nm to 300 nm is formed on a core material of graphitizable carbon.

The negative electrode active material NM17 having the core material made of amorphous carbon (hard carbon) is such that pulverized graphite powder is subjected to heat treatment with phenolic resin and then classified, powder having a median diameter D₅₀ of 20 μm is used as the core material, and a covering layer made of naphthalene is formed on a surface of the core material. NM21 is a negative electrode active material in which artificial graphite synthesized by burning petroleum pitch at a low temperature of 1500° C. is used as a core material, and a covering layer made of naphthalene is formed.

For the above 21 types of negative electrode active materials, a (002) interplanar spacing d₀₀₂, a specific surface area ratio, and a Raman peak intensity ratio (I₁₃₆₀/I₁₅₈₀) at positions of 1580 cm⁻¹ (G band) and 1360 cm⁻¹ (D band) were measured. The results are shown in Table 1.

TABLE 1
Physical properties of negative electrode active materials

| Negative | | Specific | Raman | | Thick- |
|---|---|---|---|---|---|
| electrode | | surface | peak | | ness of |
| active | d₀₀₂ | area | intensity | D₅₀ | covering |
| material | (nm) | ratio | ratio | (μm) | layer (nm) |
| NM1 | 0.3345-0.3355 | 35 ± 3 | 0.1 | 20 | 1-2 |
| NM2 | 0.3345-0.3355 | 28 ± 2 | 0.1 | 20 | 5 |
| NM3 | 0.3345-0.3355 | 25 ± 2 | 0.2 | 20 | 20 |
| NM4 | 0.3345-0.3355 | 23 ± 2 | 0.3 | 20 | 50 |
| NM5 | 0.3345-0.3355 | 20 ± 2 | 0.4 | 20 | 100 |
| NM6 | 0.3345-0.3355 | 16 ± 2 | 0.4 | 20 | 150 |
| NM7 | 0.3345-0.3355 | 11 ± 2 | 0.5 | 20 | 200 |
| NM8 | 0.3345-0.3355 | 21 ± 2 | 0.2 | 3 | 100 |
| NM9 | 0.3345-0.3355 | 21 ± 2 | 0.2 | 10 | 100 |
| NM10 | 0.3345-0.3355 | 21 ± 2 | 0.2 | 30 | 100 |
| NM11 | 0.3345-0.3355 | 1.2-1.9 | 0.6 | 10 | 100 |
| NM12 | 0.3360-0.3370 | 29 ± 2 | 0.3 | 10 | 5 |
| NM13 | 0.3360-0.3370 | 21 ± 2 | 0.5 | 10 | 100 |
| NM14 | 0.3360-0.3370 | 9 ± 2 | 0.6 | 10 | 200 |
| NM15 | 0.3345-0.3355 | 21 ± 2 | 0.2 | 40 | 100 |
| NM16 | 0.3345-0.3355 | 8 ± 2 | 0.08 | 20 | 0 |
| (Comparative | | | | | |
| example) | | | | | |
| NM17 | Cannot be | 4 ± 2 | 0.9-1.1 | 20 | 0 |
| (Comparative | determined | | | | |
| example) | (amorphous | | | | |
| | structure) | | | | |
| NM18 | 0.3345-0.3355 | 32 ± 2 | 0.1 | 20 | 1 (With |
| (Comparative | | | | | exposed |
| example) | | | | | surface) |
| NM19 | 0.3345-0.3355 | 7 ± 2 | 0.5 | 20 | 250-300 |
| (Comparative | | | | | |
| example) | | | | | |
| NM20 | 0.3345-0.3355 | 7 ± 2 | 0.5-0.6 | 30 | 250-300 |
| (Comparative | | | | | |
| example) | | | | | |
| NM21 | 0.3380-0.3395 | 6 ± 2 | 0.9-1.1 | 20 | 250-300 |
| (Comparative | | | | | |
| example) | | | | | |

The specific surface area ratio in Table 1 is calculated from specific surface areas of a negative electrode active material measured by two types of approaches as described above. Specifically, the specific surface area ratio is a ratio of a specific surface area measured by gas adsorption using a nitrogen gas to a specific surface area calculated based on particle size distribution of an equal volume sphere.

The results in Table 1 will be described. The negative electrode active materials NM1 to NM11, NM15, NM16, and NM18 to NM20 use a common core material. Because of high crystallinity of the core material, the spacing d₀₀₂ is extremely close to d₀₀₂ of natural graphite. The core material in NM12 to NM14, and NM21 has slightly lower crystallinity, and has slightly larger d₀₀₂. Since NM17 included amorphous carbon (hard carbon), it was impossible to precisely determine d₀₀₂.

The specific surface area ratio tends to decrease with increasing thickness of the covering layer. Since minute irregularities in the core material surface decreases with increasing covering layer, the specific surface area by gas adsorption decreases. On the other hand, the specific surface area calculated from an integrated value of surface areas of an equal volume sphere corresponding to a particle size measured by particle size distribution measurement is hardly influenced by the thickness of the covering layer. This is because the thickness of the covering layer is negligibly small with respect to the particle size. The latter specific surface area changes little, while the former specific surface area decreases with increasing thickness of the covering layer, and thus the specific surface area ratio is likely to decrease.

The Raman peak intensity ratio increases with increasing thickness of the covering layer. This is because the G band mainly reflects the structure of the core material and does not change, while the intensity of the D band derived from a disturbed structure of the covering layer relatively increases with increasing thickness of the covering layer.

The thickness of the covering layer influences diffusibility of lithium ions and thus needs to be within an appropriate range, and in the present invention, the thickness of the covering layer is 1 nm to 200 nm.

Since the thickness of the covering layer is sufficiently small with respect to the particle size of graphite, the median diameter D₅₀ of the negative electrode active material depends on the type of the core material, and the median diameter D₅₀ is 3 μm for NM8, 10 μm for NM9 and NM11 to NM14, 40 μm for NM15, 20 μm for NM1 to NM7, NM16 to NM19 and NM21, and 30 μm for NM10 and NM20. The median diameter D₅₀ was controlled by adjusting a pulverizing condition and a classifying condition.

The thickness of the covering layer can be controlled by an addition amount of raw material added for covering. The thickness of the covering layer in Table 1 is an average value. Specifically, sections of a plurality of negative electrode active material particles are exposed by a focused ion beam system (FIB), and an average value of thicknesses at 10 or more measurement points is shown. The covering layer was formed on the entire surface except the negative electrode active material NM18. Since NM18 has a thin covering layer, the core material was locally exposed.

For the fabricated negative electrode active material, a conical probe was used to measure a bulk modulus. Measurement was performed five times for each of the core material and the covering layer. Table 2 shows a range of values including a minimum value and a maximum value of a bulk modulus ratio calculated from the measurement values (bulk modulus of the covering layer/bulk modulus of the core material).

TABLE 2
Bulk modulus ratio of negative electrode active material and
electrochemical property of lithium ion secondary battery

| Negative | | | | |
|---|---|---|---|---|
| electrode | Bulk | Initial | 3 C | Capacity |
| active | modulus | capacity | capacity | maintenance |
| material | ratio (%) | (mAh/g) | ratio (%) | rate (%) |
| NM1 | 89-95 | 355 ± 5 | 94 | 95 |
| NM2 | 78-84 | 355 ± 5 | 94 | 95 |
| NM3 | 66-72 | 354 ± 5 | 93 | 96 |
| NM4 | 59-65 | 354 ± 5 | 93 | 97 |
| NM5 | 55-61 | 354 ± 5 | 93 | 98 |
| NM6 | 52-58 | 352 ± 5 | 92 | 98 |
| NM7 | 50-56 | 350 ± 5 | 91 | 97 |
| NM8 | 50-56 | 355 ± 5 | 97 | 97 |
| NM9 | 52-58 | 354 ± 5 | 95 | 98 |
| NM10 | 58-64 | 354 ± 5 | 90 | 98 |
| NM11 | 84-90 | 355 ± 5 | 96 | 96 |
| NM12 | 79-85 | 345 ± 5 | 96 | 93 |
| NM13 | 57-63 | 345 ± 5 | 94 | 95 |
| NM14 | 52-58 | 345 ± 5 | 93 | 97 |
| NM15 | 61-67 | 350 ± 10 | 84 | 90 |
| NM16 | (Cannot | 353 ± 5 | 89 | 75 |
| (Comparative | be | | | |
| example) | measured) | | | |
| NM17 | (Cannot | 330 ± 5 | 92 | 77 |
| (Comparative | be | | | |
| example) | measured) | | | |
| NM18 | 96-100 | 352 ± 5 | 90 | 78 |
| (Comparative | | | | |
| example) | | | | |
| NM19 | 41-49 | 330 ± 10 | 87 | 92 |
| (Comparative | | | | |
| example) | | | | |
| NM20 | 42-50 | 290 ± 10 | 85 | 91 |
| (Comparative | | | | |
| example) | | | | |
| NM21 | 40-48 | 325 ± 10 | 87 | 92 |
| (Comparative | | | | |
| example) | | | | |

For reference, besides the method of measuring the bulk modulus from one negative electrode active material particle before and after formation of the covering layer as described above, the bulk modulus of the negative electrode active material was also measured by a method of fabricating a negative electrode and then processing the negative electrode to evaluate a difference from the bulk modulus measured from the one negative electrode active material particle. The latter method is used to consider whether the latter method can predict the bulk modulus of the negative electrode active material before fabrication of the negative electrode because if a negative electrode active material is mixed in an actual negative electrode, the bulk modulus cannot be directly measured.

First, a position where the negative electrode active material particle is exposed in a mixture layer including the negative electrode active material is observed. This observation is performed using known observation means such as an optical microscope, or a scanning electron microscope. A probe for a nanoindentation approach was pressed on a substantially central position of a found negative electrode active material particle to measure a bulk modulus. This is a bulk modulus of the covering layer. The atomic force microscopy described above may be used.

Next, a method of measuring the bulk modulus of the core material in the negative electrode active material will be described. First, a layer of the negative electrode is cut perpendicularly to a plane of a negative electrode power collector. Then, a section of one negative electrode active material particle is cut out by ion milling. Examples of the section exposing method include known methods such as a focused ion beam (FIB) method, a cutting method using ultra-microtome, chemical polishing, electropolishing, ion polishing, or physical polishing using a polish (buffing, emery paper polishing). Also, to avoid degradation such as movement, collapse, or damage of a particle during cutting, a smooth section can be obtained by cutting the negative electrode in a frozen state using a cryogenic coolant such as liquid nitrogen, and thus cutting in a frozen state is desirable.

The particle size of the negative electrode active material particle is measured before exposure of the section to confirm that the size is substantially equal to the size of the section observed after the exposure of the section, and thus find that the substantial center of the particle has been cut. As such, the section of the negative electrode active material particle was exposed, and then the probe for nanoindentation was pressed on the section to measure the bulk modulus. The probe used for measurement has a regular triangular pyramidal (Berkovich type) tip formed of a diamond chip. An indenter to which the probe is mounted was pressed into a particle surface of the negative electrode active material to calculate a bulk modulus from a load on the indenter and a projection area under the indenter (see Kobe Steel Engineering Reports, Vol. 52, No. 2, pp. 74 to 77, 2002). The measured value is a bulk modulus of the core material. The atomic force microscopy described above may be used.

The ratio between the bulk modulus of the covering layer and the bulk modulus of the core material was calculated, and was substantially the same as the bulk modulus ratio measured from the one negative electrode active material particle before fabrication of the negative electrode.

The bulk modulus of the core material itself used in NM1 to NM11, NM15, and NM18 to NM21 was 9 GPa to 11 GPa (11 GPa on average). The bulk modulus of the core material in NM12 to NM14 was 8 GPa to 10 GPa (9 GPa on average). The bulk modulus of the core material in NM21 was 6 to 8 GPa (7 GPa on average).

The bulk modulus ratio tended to decrease with increasing thickness of the covering layer. This is apparent from the measurement results for NM1 to NM7 (see Table 2). This is likely to be because the bulk modulus of the covering layer is lower than the bulk modulus of the core material, and thus the increasing thickness of the covering layer causes the bulk modulus of the covering layer itself to be reflected on the measurement result. For the negative electrode active materials NM16 and NM17 without the covering layer, the bulk modulus of the covering layer cannot be measured, and “cannot be measured” was written in the column of the bulk modulus ratio.

From the results in Tables 1 and 2, the bulk modulus ratio of the negative electrode active material appears to have a monotonous correlation with the thickness of the covering layer. However, it is considered that the bulk modulus ratio is not determined only by the thickness of the covering layer, and is not limited to the results in Table 2. This is because the bulk modulus of the covering layer is influenced by orientation or alignment of crystal in micro- or nano-size that constitutes the covering layer, a carbon-carbon bonding distance, or the like. Thus, the bulk modulus of the covering layer can be controlled by changing the type of the raw material for forming the covering layer, the fabrication procedure of the covering layer, the fabrication condition, or the like. For example, the heat treatment temperature can be changed to control density of the covering layer, thereby changing the bulk modulus of the covering layer. The heat treatment temperature in forming the covering layer is set to a high temperature of 2500° C. to 3500° C. to increase the density of the covering layer, and increase the bulk modulus of the covering layer itself, thereby increasing the bulk modulus ratio to 80% to 95%.

### (Fabrication of Lithium Ion Secondary Battery)

Next, the negative electrode active materials described above were used to fabricate the lithium ion secondary battery shown in FIG. 1. Five lithium ion secondary batteries were fabricated for each negative electrode active material. The respective fabricated batteries are hereinafter denoted by the symbols (NM1, NM2, NM3, NM4, NM5, NM6, NM7, NM8, NM9, NM10, NM11, NM12, NM13, NM14, and NM15) for the negative electrode active materials used in the batteries. The weight of the negative electrode active material used in each battery is 10±0.1 g, and a rated capacity (calculated value) of the battery calculated from the weight of the negative electrode and the weight of the positive electrode is 3.5 Ah.

The negative electrode active materials NM16 to NM21 as the comparative examples were used to respectively fabricate lithium ion secondary batteries. The batteries are denoted by NM16, NM17, NM18, NM19, NM20, and NM21 correspondingly to the negative electrode active materials used therein. The rated capacity of each battery was 3.5 Ah.

The negative electrode was fabricated by separately weighing 21 types of negative electrode active materials shown in Table 1, adding 1 part by weight of styrene-butadiene rubber and 1 part by weight of carbocymethylcellulose to 98 parts by weight of each negative electrode active material to prepare a negative electrode slurry, applying the negative electrode slurry as a power collector to a surface of rolled copper foil having a thickness of 10 μm, and drying the negative electrode slurry. The negative electrode mixture density was 1.5 g/cm³.

As the positive electrode active material, LiNi_{1/3}Co_{1/3}Mn_{1/3}O₂ was used. The positive electrode mixture contained a positive electrode active material, acetylene black, and PVDF at a ratio of 89:4:7 (weight ratio). As the solvent of the slurry, 1-methyl-2-pyrrolidone was used. The positive electrode slurry was dispersed by a known kneader or disperser. As a power collector of the positive electrode, rolled aluminum foil having a thickness of 20 μm was used.

Further, as a non-aqueous electrolyte of the lithium ion secondary battery, LiPF₆ dissolved at 1 molar concentration (1 M=1 mol/dm³) into a mixed solvent of ethylene carbonate (EC) and ethylmethylcarbonate (EMC) was used. A mixing ratio of EC to EMC was 1:2 by volume ratio. To the non-aqueous electrolyte, 1% vinylene carbonate was added.

### (Evaluation on Lithium Ion Secondary Battery)

The 21 types of fabricated batteries (five batteries were fabricated for each negative electrode active material) were subjected to initial aging. First, charging was started from a state of an open circuit. The current was 3.5 A, the voltage was maintained at 4.2 V after reaching 4.2 V, and charging was continued until the current reached 0.1 A. Then, after a pause of 30 minutes, discharging was started at 3.5 A. When the battery voltage reached 3.0 V, the discharging was stopped to take a pause of 30 minutes. Similarly, charging and discharging were repeated five times, and the initial aging of the battery was finished. A discharge capacity of the last cycle (fifth cycle) was divided by the weight (10±0.1 g) of the negative electrode active material to calculate the initial capacity, and the capacity was a reference capacity. The results are shown in Table 2.

The discharge capacity of a 3 C rate (current of 10.5 A) was measured, and a capacity ratio (3 C capacity ratio) with respect to the reference capacity was calculated. The results are shown in Table 2.

Further, for the 21 types of lithium ion secondary batteries after the initial aging, cycle tests were performed under the same charge-discharge condition as the initial aging at an environmental temperature of 50° C. Table 2 shows an average value of a capacity maintenance rate after 300 cycles.

From the results in Table 2, for NM1, NM2, NM3, NM4, NM5, NM6, NM7, NM8, NM9, NM10, NM11, NM12, NM13, NM14, and NM15, a large initial capacity was obtained. For NM12, NM13, and NM14 using the negative electrode active material with slightly larger d₀₀₂ of the core material, the initial capacity slightly decreased, but a high discharge capacity of 345 mAh/g or more was obtained. Also for NM8, NM9, NM11, NM12, NM13, and NM14 with a reduced particle size of the negative electrode active material, the initial capacity was high and 350 mAh/g or more. Further, the covering layer was thin and 200 nm or less, thereby increasing the 3C capacity ratio.

NM16 using the negative electrode active material of the comparative example includes only the core material, and thus has a large irreversible capacity and a reduced initial capacity. This is not because the negative electrode degrades, but because the large irreversible capacity reduces the capacity of the positive electrode to reduce an operation range of the negative electrode that allows charging and discharging as the battery. The irreversible capacity is a value of an amount of loss of lithium consumed by decomposition reaction of the non-aqueous electrolyte that occurs due to absence of the covering layer, converted by a quantity of electricity. Without the covering layer, the capacity maintenance rate decreased.

For NM17 using the negative electrode active material of the comparative example, the negative electrode active material was amorphous carbon, and thus had a low capacity. The 3 C capacity ratio was higher than that of NM16, but the capacity maintenance rate decreased. This may result from the decomposition reaction of the electrolyte occurring on the negative electrode surface.

For NM18 using the negative electrode active material of the comparative example, the initial capacity similarly decreased with increasing irreversible capacity due to insufficient covering. The capacity maintenance rate also decreased.

For NM19, NM20, and NM21 using the negative electrode active material of the comparative example, the covering layer has a sufficiently large thickness, and thus the irreversible capacity itself decreased. However, the covering layer that was unlikely to contribute to charging and discharging increased, thereby reducing the initial capacity.

For NM21 using the negative electrode active material of the comparative example, d₀₀₂ was too large, thereby reducing the initial capacity. Further, the covering layer exceeded 200 nm, thereby reducing the 3 C capacity ratio. The capacity maintenance rate is improved as compared to NM17 and NM18, but is lower than that of the negative electrode active material of the present invention (NM1 to NM14). This may be because too thick a covering layer reduces a diffusion speed of lithium ions to cause reaction of Li on the surface with the electrolyte.

The above described results are summarized as described below.

First, the negative electrode active material has a two-layer structure including the core material and the covering layer, and controlling the thickness of the covering layer to 1 m to 200 nm increases the capacity maintenance rate of the negative electrode. This is apparent from the results for NM1 to NM15 and comparison with the comparative examples.

Second, it was found that when the bulk modulus of the covering layer was lower than the bulk modulus of the core material, the capacity maintenance rate increased. It was also found that the ratio of bulk modulus was preferably 50% or more. This is apparent from the results for NM1 to NM14, and comparison with the comparative examples NM19 to NM21.

To increase the life of the negative electrode, it is conceivable that the bulk moduli of the core material and the covering layer are defined by actual measurement values, and a relationship between the difference between the bulk moduli and the life of the negative electrode active material is studied. However, it has been found that according to the present invention, the bulk modulus ratio presents a good correlation with the negative electrode. Occlusion and emission of the lithium ions changes the volume of the core material. An important point of the present invention is to prevent separation of the covering layer from the core material surface in accordance with the change. The separation of the covering layer is likely to depend on the ratio between the bulk moduli of the core material and the covering layer rather than the values of the bulk moduli. If the ratio exceeds a certain limit value, the covering layer cannot follow the change in volume of the core material, and the covering layer is likely to be separated from the core material. The present invention was completed by finding that the ratio between the bulk moduli of the core material and the covering layer is more important than the difference between the bulk moduli and clarifying the relationship between the core material and the covering layer.

Third, the ratio between the specific surface area of the negative electrode active material calculated based on the particle size distribution of the equal volume sphere of the negative electrode active material and the specific surface area actually measured by gas adsorption is 1:1 to 1:30, and the (002) interplanar spacing of the core material is 0.3345 nm to 0.3370 nm, and the ratio I₁₃₆₀/I₁₅₈₀ (Raman peak intensity ratio) of the peak intensity of the 1360 cm⁻¹ region (D band) to the peak intensity of the 1580 cm⁻¹ region (G band) is 0.1 to 0.6, and then a battery having a high capacity and a long life is obtained. The ratio between specific surface areas is apparent from comparison of NM1 to NM7 and NM11 with NM18 as the comparative example. The (002) interplanar spacing is apparent from comparison of NM9, NM13 and NM14 with NM16 and NM17 as the comparative examples. The Raman peak intensity ratio is apparent from comparison of NM1 to NM14 with NM16, NM17 and NM21 as the comparative examples.

Fourth, if the particle size (median diameter D₅₀) of the negative electrode active material at a frequency of 50% calculated from the particle size distribution measurement is particularly 3 μm to 30 μm within the range in the present invention, a negative electrode having a higher capacity and a longer life can be obtained. This is apparent from comparison of NM5 and NM8 to NM10 with NM15.

### (Evaluation on Direct Current Resistance)

Then, the cycle test was performed, and direct current resistance (DCR) after 300 cycles was measured. The direct current resistance was measured as described below. First, the negative electrode and the positive electrode were taken out from the battery to assemble a three-electrode cell using the negative electrode as a working electrode, the positive electrode as a counter electrode, and metallic lithium as a reference electrode. This cell was used to charge the negative electrode to the same level as for the battery. Then, the negative electrode was discharged at a constant discharge current value within a range of 1 nmA/cm² to 10 mA/cm², and a variation width of a negative electrode potential in 10 seconds after the start of discharge was measured. The negative electrode potential was measured with reference to the reference electrode. The discharge current was plotted on the abscissa, and the variation width of the potential was plotted on the ordinate, and an inclination of a linear approximation was taken as direct current resistance.

The resistance increase rate of the negative electrode active materials NM1 to NM14 tends to inversely decrease with increasing capacity maintenance rate, and the resistance increase rate was 5% to 15%. For example, the direct current resistance for NM1 to NM7 was 5% to 15% of the initial value, and the resistance tended to decrease with increasing thickness of the covering layer. For NM8 to NM10, the resistance tended to increase with decreasing particle size, but the DCR increase rate was 5% to 10%. The resistance increase rate of NM11 was 7%. The resistance increase rate of NM12 to NM14 was 5% to 10%. Also in this case, the resistance highly depended on the thickness of the covering layer, and tended to decrease with increasing covering layer.

The negative electrode of NM16 to NM18 as the comparative examples had a significantly reduced capacity maintenance rate, and thus had a high resistance increase rate. The resistance increase rate was 250% for NM16, 210% for NM17, and 195% for NM18. The capacity maintenance rate of the negative electrode of NM15, and NM19 to NM21 was improved as compared to the value of the negative electrode of NM16 to NM18, but the resistance increase rate was 120% to 180%, and the resistance increase rate tended to increase with decreasing capacity maintenance rate.

### (Charge-Discharge Test of Negative Electrode)

After the charge-discharge cycle test was finished, the battery was fully discharged to 3.0 V. The battery was moved to a glove box including an argon gas, each battery was disassembled in argon gas atmosphere, and only the negative electrode was taken out. The negative electrode, the non-aqueous electrolyte having the same composition used in each battery, and the electrode of metallic lithium were combined to conduct the charge-discharge test of the negative electrode. The charging current was at a value corresponding to 100 mA/g, and after the negative electrode potential reached 10 mV, charging at 10 mV was continued until the current decreased to 10 mA/g. Then, after a pause of 30 minutes, the negative electrode was discharged at the same current until the negative electrode potential reached 1.0 V. The charge-discharge cycle test was performed three times.

Therefore, the negative electrode active materials NM1 to NM15 held a large discharge capacity of 340 mAh/g to 355 mAh/g. For NM16 to NM18 as the comparative examples, the discharge capacity decreased to 250 mAh/g to 260 mAh/g, 275 mAh/g to 285 mAh/g, and 290 mAh to 300 mAh, respectively. The discharge capacity of NM19 to NM21 also decreases from the initial capacity to 290 to 330 mAh/g.

### (Fabrication Example of Battery Module)

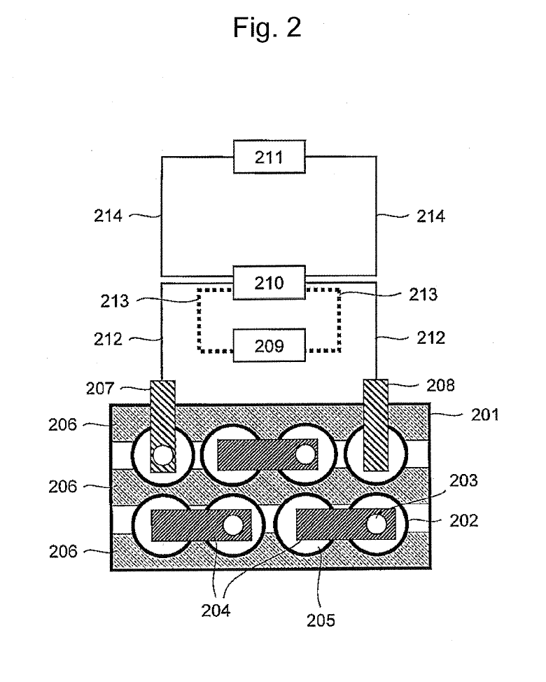

A plurality of cylindrical lithium ion secondary batteries shown in FIG. 1 were connected to assemble a battery module (assembled battery) 201 as shown in FIG. 2. The battery module 201 includes eight lithium ion secondary batteries 202 connected in series. To the battery module 201, a charge-discharge circuit 210, an arithmetic processing unit 209, a feed load power source 211, a power line 212, a signal line 213, and an external power cable 214 were connected. The system in FIG. 2 further includes a positive electrode terminal 203, a bus bar 204, a battery can 205, and a support member 206. NM1 was used as the eight lithium ion secondary batteries 202.

This example is a test for confirming effectiveness of the present invention, and thus the feed load power source 211 having both functions of supplying and consuming electric power was used instead of an external power source or an external load being mounted. Using the feed load power source 211 does not provide any difference in the advantage of the present invention as compared to the case of actual use in an electric vehicle such as an electric vehicle, a machining tool, a distributed electric power storage system, a backup power source system, or the like.

As a charging test immediately after assembly of the system shown in FIG. 2, a charging current of a current value (3.5 A) corresponding to one hour rate was passed from the charge-discharge circuit 210 to the positive electrode external terminal 207 and the negative electrode external terminal 208 to perform charging for one hour at a constant voltage of 33.6 V. The constant voltage value set herein was 8 times a constant voltage value of 4.2 V of a single cell. The feed load power source 211 was used to supply and receive electric power required for charging and discharging the battery module.

In a discharge test, a current in an opposite direction was passed from the positive electrode external terminal 207 and the negative electrode external terminal 208 to the charge-discharge circuit 210 to cause the feed load power source 211 to consume electric power. The discharge current was under a condition of one hour rate (3.5 A as discharge current), and discharging was performed until an inter-terminal voltage between the positive electrode external terminal 207 and the negative electrode external terminal 208 reached 24 V.

Under such a charge-discharge test condition, initial performance with a charging capacity of 3.5 Ah and a discharge capacity of 3.4 Ah to 3.5 Ah was obtained. Further, the charge-discharge cycle test for 300 cycles was conducted to obtain a capacity maintenance rate of 94% to 95%. This system is referred to as S1.

Also, a system was fabricated using a battery including the negative electrode active material NM21 in Table 1 instead of the battery NM1. This system is referred to as S2. The charge-discharge cycle test for 300 cycles was conducted under the same condition as above. As a result, the capacity maintenance rate of S2 was 83% to 85%, and it was found that the negative electrode active material of the present invention was effective for improving the cycle property of the lithium ion secondary battery.

The present invention is not limited to the examples described above. Specific configuration materials or parts may be changed within the gist of the present invention. As long as the components of the present invention are included, a known technique may be added or a part of the components may be replaced by the known technique.

The lithium ion secondary battery according to the present invention may be used as a power source for consumer products such as a portable electronic device, a cell phone, or an electric tool, an electric automobile, an electric train, a storage battery for renewable energy, a driverless mobile vehicle, care equipment, or the like. Further, the lithium ion secondary battery according to the present invention may be used as a power source for a logistic train for exploring the moon or the Mars. Also, the lithium ion secondary battery according to the present invention may be used as various power sources for air conditioning, temperature adjustment, purification of polluted water or air, power or the like in various spaces such as a space suit, a space station, a building or a life space on the earth or other celestial bodies (both enclosed or opened), a spaceship for movement between planets, a land rover, an enclosed space under water or the sea, a submarine, or a facility for observing fish.

### REFERENCE SIGNS LIST

101 lithium ion secondary battery
110 positive electrode
111 separator
112 negative electrode
113 battery can
114 positive electrode power collection tab
115 negative electrode power collection tab
116 inner lid
117 internal pressure open valve
118 gasket
119 positive temperature coefficient (PTC) resistance element
120 battery lid with positive electrode terminal
201 battery module
202 lithium ion secondary battery
203 positive electrode terminal
204 bus bar
205 battery can
206 support member
207 positive electrode external terminal
208 negative electrode external terminal
209 arithmetic processing unit
210 charge-discharge circuit
211 feed load power source
212 power line
213 signal line
214 external power cable

1. A negative electrode active material for a lithium ion secondary battery, the negative electrode active material comprising: a graphite core material; and a covering layer that covers a surface of the core material, wherein the covering layer has a thickness of 1 nm to 200 nm, and has a bulk modulus lower than a bulk modulus of the core material.

2. The negative electrode active material of claim 1, wherein the bulk modulus of the covering layer is 50% to 95% of the bulk modulus of the core material.

3. The negative electrode active material of claim 1, wherein a ratio between a specific surface area of the negative electrode active material calculated based on particle size distribution of an equal volume sphere of the negative electrode active material and a specific surface area of the negative electrode active material measured by gas adsorption is 1:1 to 1:30, a (002) interplanar spacing of the core material is 0.3345 nm to 0.3370 nm, and a ratio I₁₃₆₀/I₁₅₈₀ of peak intensity of a 1360 cm⁻¹ region (D band) to peak intensity of a 1580 cm⁻¹ region (G band) is 0.1 to 0.6.

4. The negative electrode active material of claim 1, wherein the covering layer has a thickness of 5 nm to 150 nm.

5. The negative electrode active material of claim 1, wherein a median diameter D₅₀ of the negative electrode active material is 3 μm to 30 μm.

6. A lithium ion secondary battery comprising: a negative electrode including the negative electrode active material of claim 1; a positive electrode; and an electrolyte.
